(19) United States
(12) Patent Application Publication
(10) Pub. No.: US 2007/0239802 A1
(43) Pub. Date: Oct. 11, 2007

(54) System and method for maintaining the genealogy of documents

(76) Inventors: Allen M. Razdow, Cambridge, MA (US); Jakov Kucan, Cambridge, MA (US); Jaime Meritt, Wilmington, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/784,510

(22) Filed: Apr. 6, 2007

Related U.S. Application Data
(60) Provisional application No. 60/790,055, filed on Apr. 7, 2006.

(51) Int. Cl. G06F 17/30

(52) U.S. Cl. 707/203

(57) ABSTRACT

A system and method that provides a mechanism for tracing the history of changes made to the content of a document by a user. The system allows a user to open an existing document, to make one or more changes to the content, to generate meta-data describing the user's intent for making the changes to the content, and to store both the changed content and the meta-data in a new document, while retaining the content of the prior document. The system automatically generates meta-data indicative of the identity of the prior document, and stores this meta-data in association with the new document at the time that document is stored or saved. If the prior document already has meta-data indicating its identity embedded within it, then the system accesses the meta-data from the prior document for subsequent storage in association with the new document. Using the stored meta-data, the system can generate a representation of a document family tree illustrating the genealogy of the document for display on a video display.

### CROSS REFERENCE TO RELATED APPLICATIONS

This application claims benefit of U.S. Provisional Patent Application No. 60/790,055 filed Apr. 7, 2006 entitled SYSTEM AND METHOD FOR MAIMTAING THE GENEALOGY OF DOCUMENTS.

### STATEMENT REGARDING FEDERALLY SPONSORED RESEARCH OR DEVELOPMENT

Not Applicable

### BACKGROUND OF THE INVENTION

The present invention relates generally to systems and methods of maintaining the traceability of documents, and more specifically to an information management system and method operative to trace the history of changes made to the content of a document by a user, including capturing information relating to the identity of an existing document from which the document was derived and the user's intent for making the changes, and storing that information in association with the document.

Users frequently employ computer software applications such as word processing applications to open, create, edit, and/or save documents or templates. For example, a user may employ a word processing application to open an existing document, to create a new document containing content derived from the prior existing document, to create a new document containing an improved version of the content of the prior document, or to create a new version of the prior document for a different purpose. In each case, the user creates a new document using at least some of the content contained in the prior existing document.

When creating a new document from an existing document, a user may or may not wish to preserve the prior existing document. For example, using a word processing application, a user may open an existing document, make changes to the content of the existing document, and create a new document by either saving the changed content over the prior existing document (SAVE), or storing the changed content in a new file while retaining a copy of the prior document in its original file (SAVE AS). Alternatively, a user may copy an existing document to a new file, assign a name to the new file that is different from the original filename of the existing document, and make changes to the content of the document contained in the new file. In addition, a user may employ the various features of the word processing application, e.g., OPEN, EDIT, SAVE, SAVE AS, COPY, PASTE, RENAME, etc., in different combinations and permutations to create a new document from an existing document. A user may also perform document creation and modification operations in association with a document management or version control system that provides additional operations for facilitating the handling of documents.

One drawback of conventional methods of creating, modifying, and saving documents is that a user's intent for making changes to the content of a document usually cannot be easily determined either from the document itself or from the operations used to make the changes. Having the ability to determine a user's intent for making changes to the content of a document can be helpful in characterizing the relationships between a new document and one or more prior documents from which the new document was derived. For example, based upon a user's intent for making the changes, it may be possible to determine whether a new document derived from a prior document is a revised version of the prior document, or a revised version that has a purpose different from that of the prior document. Further, based upon the user's intent for making the changes, it may be possible to determine whether the changes are substantive or relate merely to document formatting or annotation. However, because conventional methods of document creation and modification do not take into account a user's intent for making changes to the content of a document, the relationships between a newly created document and one or more prior documents from which the new document was derived cannot be easily ascertained.

It would therefore be desirable to have a system and method of tracing the history of changes made to the content of a document by a user that provides a mechanism for characterizing the relationships between a document and one or more prior documents from which that document was derived. Such a system and method would take into account the identity of each prior document, and the user's intent for making the changes.

### BRIEF SUMMARY OF THE INVENTION

In accordance with the present invention, an information management system and method is disclosed that provides a mechanism for tracing the history of changes made to the content of a document by a user, including capturing information relating to the identity of a prior existing document from which the document was derived and the user's intent for making the changes, and storing that information in association with the document. The presently disclosed system and method maintains a representation of the genealogy of a document, which can be employed to characterize and mine the relationships between multiple existing documents based upon common document usage models.

In one mode of operation, the presently disclosed system allows a user to open an existing document, to make one or more changes or modifications to the content of the existing document, to generate meta-data describing the user's intent for making the changes (the “user-generated meta-data”), and to save the changed content and the user-generated meta-data in association with a new document, while retaining the original version of the prior document. For example, the prior existing document may be a worksheet, a spreadsheet, a table, a data file, a media file, a program file, or any other suitable type of document. Further, the prior document may be retained within the system in its original file, while the information contained in the new document may be retained within the system in a new file. Alternatively, the files containing the prior document and the new document may be stored in a shared database accessible by the system. The disclosed system is configured for automatically generating meta-data indicative of the identity of the prior document (the “system-generated meta-data”), and for storing the system-generated meta-data in association with the newly created document at the time the new document is saved. If the prior document already has meta-data indicating its identity embedded within it, then the system can access that meta-data from the prior document for subsequent storage in association with the new document.

The presently disclosed system and method allows a user to access the system-generated and user-generated meta-data associated with a document to determine the relationships that may exist between the document and one or more prior existing documents from which that document was derived. Such relationships between multiple existing documents may be characterized based upon common document usage models. For example, a new document may constitute a revision, a repurposing, or a reformatting of a prior document. Alternatively, a new document may have the same content as a prior document, but may contain different meta-data. In one embodiment, the system-generated meta-data indicating the identity of a prior document comprises the globally unique identifier (GUID), which is generated from the content of the prior document. Both the system-generated meta-data, e.g., the GUID of the prior document, and the user-generated meta-data, i.e., the indication of the user's intent for making the changes, are maintained with each new document derived from the prior document. For example, the system-generated and user-generated meta-data may be stored in respective meta-data fields embedded within the new document. In addition, each version of a document, and each revision of an older version of that document, is saved in document storage. Accordingly, each time a user opens a document, makes one or more changes to the content of the document, and then saves the changed content, e.g., in a file, a new document is created, while the prior document is retained, e.g., in its original file.

In one embodiment, the presently disclosed system includes a document storage system, at least one processor, one or more input devices such as a mouse and a keyboard, and at least one output device such as a video monitor or display. The document storage system may include at least one memory, hard drive, floppy drive, writable optical drive, or any other storage mechanism suitable for maintaining and storing documents, and for maintaining and storing user-generated and system-generated meta-data in association with the documents. The user-generated and system-generated meta-data are stored and maintained with its associated document using a specified data structure. The processor is operative to execute at least one software program out of at least one memory for automatically generating the system-generated meta-data, and for embedding the user-generated and system-generated meta-data within a new document derived from a prior existing document. A user can access both the user-generated meta-data and the system-generated meta-data by viewing representations of the information contained in the respective meta-data on the video display. In addition, using the user-generated and system-generated meta-data associated with a document, the disclosed system can generate a representation of a tree structure illustrating the genealogy of the document (the “document genealogy tree”) for display on the video display.

Because both the identity of an existing document and a user's intent for making one or more changes to the content of the existing document are stored as meta-data with each new document derived from the prior existing document, a user can access this meta-data to determine the relationships between each new document and one or more prior documents from which the new document was derived. For example, by accessing such meta-data embedded within a document, a user can determine whether or not there is a more recent and perhaps more useful version of that document, which may be employed in a new document the user may currently be in the process of creating. In addition, a user can determine the identities of one or more existing documents that might be impacted by any changes he or she may be making to the content of a particular document.

Other features, functions, and aspects of the invention will be evident from the Detailed Description of the Invention that follows.

### BRIEF DESCRIPTION OF THE SEVERAL VIEWS OF THE DRAWINGS

The invention will be more fully understood with reference to the following Detailed Description of the Invention in conjunction with the drawings of which:

FIG. 1 is a block diagram of an information management system operative to trace the history of changes made to the content of a document by a user, according to the present invention;

FIG. 2 illustrates a logical grouping of elements associated with a document that may be operated on by the system of FIG. 1;

FIG. 3 is a diagram illustrating various categories of documents that may be derived from a document operated on by the system of FIG. 1;

FIG. 4 is a diagram depicting a representation of a tree structure illustrating the genealogy of a document (the “document genealogy tree”) operated on by the system of FIG. 1; and

FIG. 5 is a flow diagram of a method of operating the system of FIG. 1.

### DETAILED DESCRIPTION OF THE INVENTION

The entire disclosure of U.S. Provisional Patent Application No. 60/790,055 filed Apr. 7, 2006 entitled SYSTEM AND METHOD FOR MAINTAINING THE GENEALOGY OF DOCUMENTS is incorporated herein by reference.

A system and method is disclosed that provides a mechanism for tracing the history of changes made to the content of a document by a user, including capturing information relating to the identity of a prior existing document from which the document was derived and the user's intent for making the changes, and storing that information in association with the document. The presently disclosed system and method maintains a representation of the genealogy of a document, which can be used to characterize and mine relationships between multiple documents based upon common document usage models.

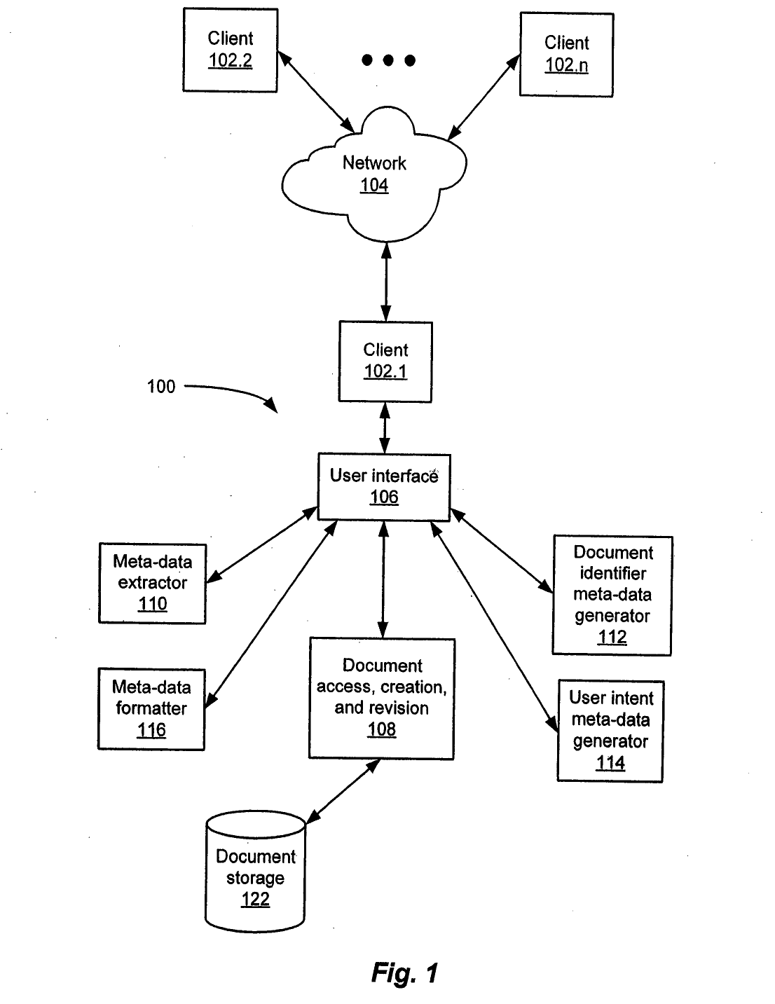

FIG. 1 depicts an illustrative embodiment of an information management system 100 for tracing the history of changes made to the content of a document by a user, in accordance with the present invention. The system 100 includes a plurality of client computers 102.1-102.n, at least one public or private communications network 104, and a plurality of client computer components including a user interface 106, a document access, creation, and revision component 108, a meta-data extractor 110, a document identifier meta-data generator 112, a user intent meta-data generator 114, a meta-data formatter 116, and a document storage component 122. In the illustrated embodiment, the system 100 is employed within a collaborative environment, in which the plurality of client computers 102.1-102.n communicate and interact with one another via the network 104. Each of the client computers 102.1-102.n may be embodied in a separate computer system operable by a user, which is typically a human operator. In an alternative embodiment, a user of the presently disclosed system may comprise a software process. Each of the client computers 102.1-102.n is communicably coupleable to the network 104, and is operative to perform the functions provided by the various system components 106, 108, 110, 112, 114, 116, and 122. FIG. 1 depicts only the client 102.1 associated with the functional components 106, 108, 110, 112, 114, 116, and 122 for clarity of illustration. However, in practice, such functional components are replicated for each of the client computers 102.1-102.n within the system 100.

Within the system 100 of FIG. 1, a user of the client 102.1 interacts with the functional components 108, 110, 112, 114, 116, and 122 via the user interface 106. For example, the user interface 106 may implement a graphical user interface (GUI) operative to allow the user to control the system operation via one or more input devices such as a mouse and a keyboard, and to view the contents of a document and meta-data associated with the document via at least one output device such as a video monitor or display.

The document access, creation, and revision component 108 is operative to enable the user to access at least one existing document from either the local document storage 122 or a remote document storage (not shown) accessible over the network 104, to open the existing document, to create a new document, and to generate at least one new version or revision of the existing document. For example, the existing document may comprise a worksheet, a spreadsheet, a table, a data file, a media file, a program file, or any other suitable type of document or information storage entity. Further, the local and remote document storage may comprise at least one memory, hard drive, floppy drive, writable optical drive, or any other suitable type of document storage mechanism.

In one embodiment, the information management system 100 operates on documents having a format based upon the extended markup language (XML). Each XML-based document has a plurality of meta-data fields embedded within or otherwise associated with the document for storing user-generated meta-data describing the user's intent for making one or more changes or modifications to the content of a prior existing document from which the document was derived, and system-generated meta-data indicating the identity of the prior document. The meta-data extractor 110 is operative to extract the meta-data stored in the respective meta-data fields of a document, and to provide the information contained in the extracted meta-data to the user interface 106 for subsequent display on the video display. Further, the user intent meta-data generator 114 is operative to enable the user to generate meta-data describing his or her intent for making one or more changes to the content of a document, and to store this descriptive meta-data in one of the respective meta-data fields embedded within a document derived from the prior document. In the illustrated embodiment, such user-generated meta-data comprises text-based meta-data.

Each time the user completes a sequence of operations including opening an existing document, making one or more changes to the content (i.e., the user-defined content and/or the user-generated meta-data) of the existing document, and saving the changed document content in a new document, the document identifier meta-data generator 112 automatically generates meta-data indicating the identity of the prior existing document from which the new document was derived. Specifically, the meta-data generator 112 generates a unique document identifier from the content (i.e., the user-defined content, the user-generated meta-data, and any system-generated meta-data) of the prior existing document. For example, the unique document identifier may be a universally unique identifier (UUID) or a globally unique identifier (GUID) comprising a multi-bit number generated as known in the art. In an alternative embodiment, the unique document identifier may comprise a UUID, a GUID, a checksum, a hash code, a digital signature, and/or any other numerical, alphabetical, alphanumeric, character, or string entity suitable for uniquely identifying a document. In the presently disclosed embodiment, each unique document identifier is generated from the content of the corresponding document. Accordingly, if a document includes a checksum, a hash code, and/or a digital signature within its content, then the unique document identifier generated for identifying that document incorporates that checksum, hash code, and/or digital signature. It is noted that if meta-data indicating the identity of a document is already embedded within the document, then the system 100 may access that meta-data from within the document instead of automatically generating such document identifier meta-data.

In addition, at the time the changed content of an existing document is saved in a new document, the document identifier meta-data generator 112 can automatically generate meta-data indicating the identity of the new document, e.g., a GUID generated from the content of the new document. Next, the document identifier meta-data generator 112 automatically stores the GUID corresponding to the prior existing document, and the GUID corresponding to the new document, in respective meta-data fields embedded within the new document. In addition, the system 100 retains the prior document, e.g., in its original file, while storing the new document, including the content from the prior document that was changed by the user, in a separate file. For example, the files corresponding to the prior existing document and the new document derived from the prior document may be stored in a file storage system, a shared database, or any other suitable type of storage media.

Within the presently disclosed system 100, user access and control of the meta-data associated with a document is achieved via a word processing application or any other suitable software agent or tool. In addition, the system 100 is operative to distinguish between a number of different types of document content, including model, instance, data, or any other suitable type of document content. Each document created, derived, and/or changed within the system 100 is a uniquely identifiable logical collection or grouping of content elements representing a fundamental unit of information. Further, each document is considered to be immutable, i.e., the content of a document cannot be changed. Instead, each new version or revision of an existing document is represented within the system 100 as a newly created document, while the content of the original version of the document is retained, e.g., in a separate file.

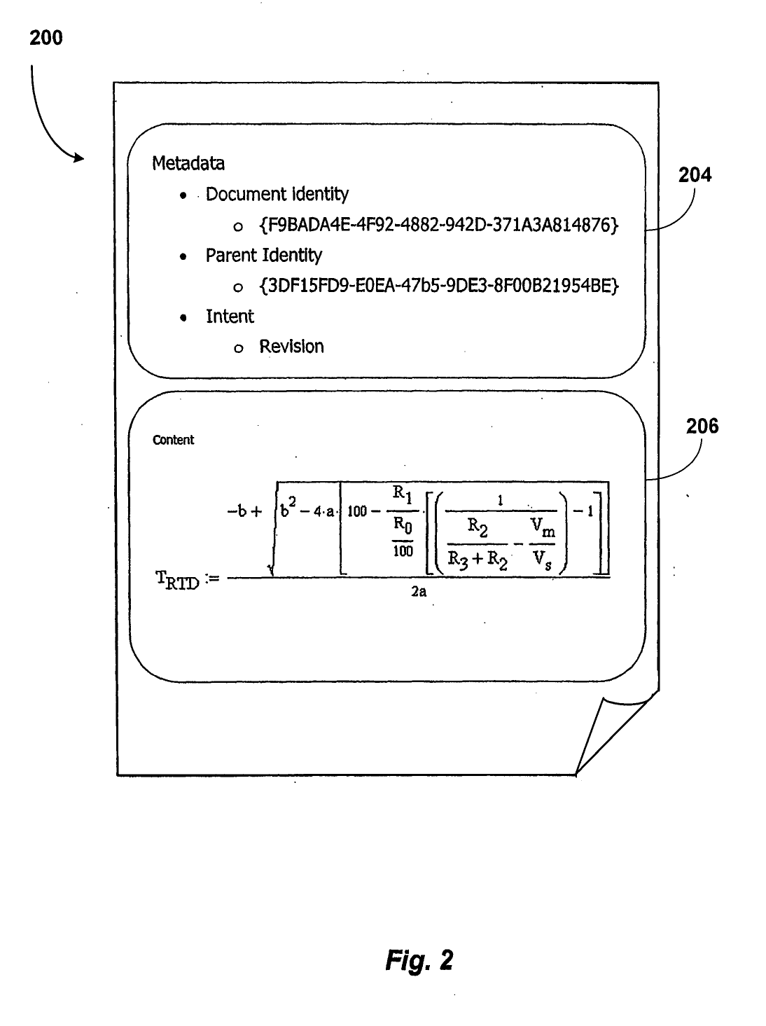

FIG. 2 depicts a document 200 including meta-data 204 and content 206 arranged in an exemplary logical grouping. For example, the illustrated logical grouping of meta-data and content may conform to the XML data model for engineering (XDME) developed by Mathsoft® Engineering & Education, Inc., Cambridge, Mass., USA, or any other suitable data model. The meta-data 204 includes descriptive information relating to the document 200. For example, the meta-data 204 may contain information such as the classification, author, modification date, title, or any other suitable information associated with the document 200. In the illustrated embodiment, the meta-data 204 contains an indication of the identity of the document 200 (“Document identity”), as defined by the globally unique identifier (GUID) generated from the content (i.e., the meta-data 204 and the content 206) of the document 200, for example, {F9BADA4E-4F92-4882-942D-371A3A814876}. It is noted that any changes made to the meta-data 204 and/or the content 206 will require a new GUID to be generated for the document 200. The meta-data 204 also contains an indication of the identity of a prior existing document (“Parent Identity”) from which the document 200 was derived, as defined by the GUID generated from the content of the prior document, for example, {3DF15FD9-E0EA-47b5-9DE3-8F00B21954BE}. The meta-data 204 also contains information describing a user's intent (“Intent”) for making one or more changes to the content of the prior document, resulting in the creation of the new document 200. In this case, the user's intent for making the changes was to create a revision (“Revision”) of the prior document. The content 206 of the document 200 includes the user-defined information carried by the document, for example,

$${T}_{RTD} = \frac{- b + \sqrt{{b}^{2} - 4 \cdot a \cdot [ 100 - \frac{{R}_{1}}{\frac{{R}_{0}}{100}} \cdot [ {( \frac{1}{\frac{{R}_{2}}{{R}_{3} + {R}_{2}} - \frac{{V}_{m}}{{V}_{s}}} )}^{- 1} ] ]}}{2 a} .$$

The user-defined information carried by the document 200 may include text, calculations, graphics, and/or any other suitable type of information.

The XDME data model employed within the presently disclosed system 100 provides a structure description mechanism with regard to the document content. A user can employ this structure description mechanism to define multiple addressable regions or segments of a document (referred to herein as “content chunks”). The system 100 allows a user to generate document-level meta-data describing his or her intent for making changes to the content of a document, and to generate region-level meta-data describing his or her intent for making changes to one or more content chunks. In addition, the system 100 can maintain representations of the genealogy of a document, and representations of the genealogy of one or more content chunks, using the information contained in the meta-data embedded within the document. The genealogy of a document, defined herein as the modification history of a document, can be represented within the presently disclosed system by a document genealogy tree, as described below.

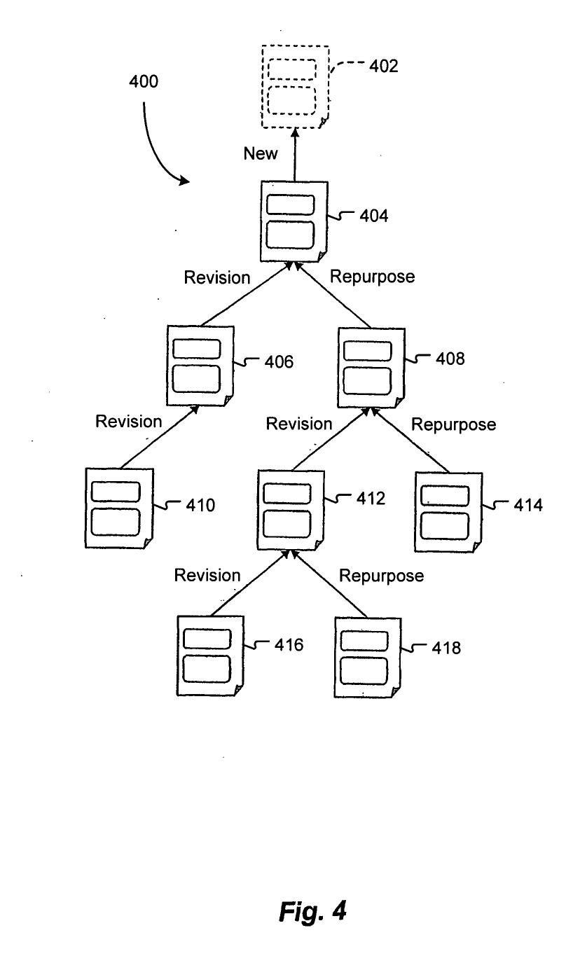

Because documents are immutable within the presently disclosed system 100, the modification of a document results in the creation of a new document. Based upon a user's intent for making changes to the content of a document, the resulting new document can be placed into one of a number of different categories of derived documents, for example, a new document, a revision of an older document (a “revision”), a repurposing of an older document (a “repurpose”), a reformatting of an older document (a “reformat”), and a new document containing only a change in meta-data (a “meta-data change”). Within the presently disclosed system 100, an existing document from which a new document was derived (the “parent document”) can be represented by the root of a document genealogy tree. The system 100 also allows a new document derived from a parent document to be represented by the root of a document genealogy tree, as described below with reference to FIG. 4.

The revision category of derived documents encompasses new documents having content intended to eclipse that of a parent document. For example, the content of a document placed in the revision category may be regarded as being more recent or better than the content of a parent document. Additional refinements of a user's intent for creating a revision are possible, e.g., the revision may relate to a correction, an improvement, an augmentation, etc., of a parent document.

The repurpose category of derived documents encompasses new documents with content intended to have a purpose different from that of a parent document. For example, when repurposing a document, a user typically does not intend to replace the content of the parent document, but to change the content to suit a different purpose. The repurposing of a document generally does not have any bearing on the validity of the content of the document. There can be further refinements of a user's intent for repurposing a document, e.g., the repurposing may relate to a general repurposing of a document, or to a specific repurposing of an instance of the document.

The reformat category of derived documents encompasses new documents having content that is reformatted. For example, when a parent document is reformatted, the resulting new document retains substantially the same semantic content as the parent document. There can be refinements of a user's intent for reformatting a document, e.g., the reformatting may relate to a published form, an extract, or an aggregation of information contained in the parent document.

The meta-data change category of derived documents encompasses new documents having content in which the embedded meta-data has been changed (e.g., the meta-data 204 of the document 200; see FIG. 2). For a new document in the meta-data change category, no changes are made to the user-defined content (e.g., the user-defined content 206 of the document 200; see FIG. 2). When making changes to the meta-data of a document, a user's intent may be to reclassify or otherwise annotate the document. For example, the user may change the meta-data to indicate the approval of a document, a change to a project, the status of a document, (e.g., provisional or final), etc.

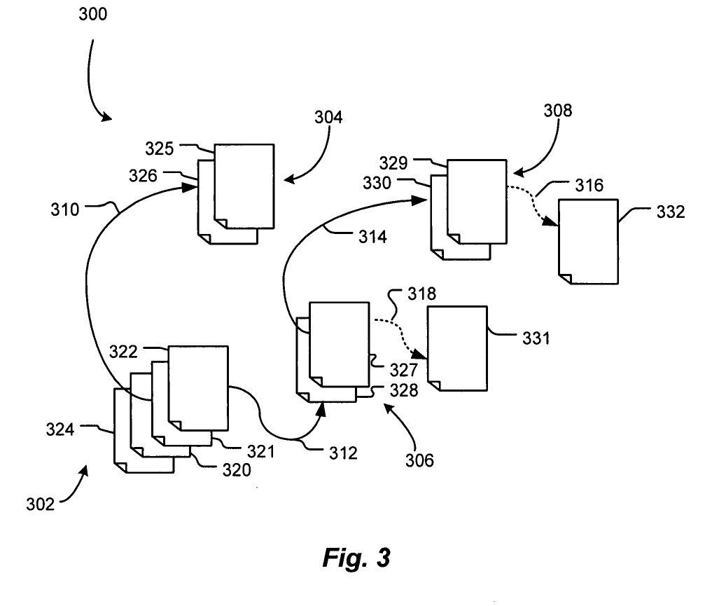

FIG. 3 is a diagram illustrating the different categories of derived documents that can be created using the information management system 100 (see FIG. 1). As shown in FIG. 3, document revisions are represented by four document stacks 302, 304, 306, and 308, document repurposes are indicated by solid lines 310, 312, and 314, and document reformats are indicated by broken lines 316 and 318. For example, documents 320-322 included in the stack 302 represent respective revisions of a parent document 324, a document 325 included in the stack 304 represents a revision of a parent document 326, a document 327 included in the stack 306 represents a revision of a parent document 328, and a document 329 included in the stack 308 represents a revision of a parent document 330. Further, the document 326 represents a repurpose of the content of the document 321, the document 328 represents a repurpose of the content of the document 322, and the document 330 represents a repurpose of the content of the document 329. Moreover, the document 332 represents a reformat of the content of the document 329, and the document 331 represents a reformat of the content of the document 327.

When changing the content of a document, a user typically has a definitive intent for making the changes. Within the presently disclosed system 100, a user's intent is declarative because it may be impossible to determine such intent by just comparing the content of a new document with the content of a parent document from which the new document was derived. For example, when changing the value of the specific thermal capacity of a material within a parent document, a user's intent for making the change may be to correct the parent document, i.e., to create a revision of the content of the parent document. Alternatively, the user's intent for making the change may be to change the purpose of a calculation made within the parent document. For example, a calculation using the new specific thermal capacity value may have a different purpose if the new value corresponds to the specific thermal capacity of a different material. Specifically, a calculation relating to how long a Styrofoam cup can keep coffee warm may be repurposed to model a paper cup.

As explained above, a user's intent for making changes to the content of a document may be described using text-based meta-data. In one embodiment, the description of the user's intent for making such changes may be selected from a predefined list. It is noted that the various possibilities of a user's intent for making the changes can sometimes be narrowed by examining the content of a new document and the content of a parent document from which the new document was derived. For example, if a parent document were a template, then the user's intent for making changes to the content of the parent document is likely to create a new document. Similarly, if the content of a new document and the content of a parent document from which the new document was derived are identical, but the meta-data associated with the respective documents are different, then the user's intent for making changes to the content of the parent document is likely to make a meta-data change. In one embodiment, the information management system 100 (see FIG. 1) is configured for automatically sensing or computing a user's intent for making changes to the content of a document by comparing the content of the document with the content of a parent document from which that document was derived. The system 100 can also be configured for automatically generating and storing the meta-data describing a user's intent for making the changes (e.g., to create a new document, a revision of a document, a repurpose of a document, or a reformat of a document, or to make a meta-data change) in association with the derived document. In some cases, the changes made to the content of a document may be merely cosmetic, e.g., such changes may include changes to the font style, the font size, and/or the font color used in the document. Accordingly, the system 100 can be configured to sense such cosmetic changes to the content of a document, and to generate and store descriptive meta-data in association with a new document derived from the original document, indicating that the changes made to the content of original document were cosmetic.

FIG. 4 depicts a representation of an exemplary document genealogy tree 400, including documents 404, 406, 408, 410, 412, 414, 416, and 418. In the presently disclosed embodiment, the information management system 100 (see FIG. 1) is configured to generate and provide one or more representations of document genealogy trees, such as the document genealogy tree 400, to the user interface 106 for subsequent display on the video display. As shown in FIG. 4, the new document 404 is the root of the document genealogy tree 400. As explained above, although the new document 404 may have a corresponding parent document, e.g., a parent document 402, a user can explicitly declare that the new document 404 is to be represented by the root of the tree 400. It is noted that the arrows and their associated legends located between the documents 406, 408 and the document 404, between the document 410 and the document 406, between the documents 412, 414 and the document 408, and between the documents 416, 418 and the document 412, are indicative of the user-generated meta-data describing the user's intent for making one or more changes to the content of a parent document, and the system-generated meta-data indicating the identity of the parent document. For example, the arrow between the documents 404 and 406 points to the document 404 to indicate that the document 404 is the parent document of the document 406. Further, the legend “Revision” associated with the arrow between the documents 404, 406 indicates that the user's intent for making changes to the content of the parent document 404 was to make a revision of the document 404, resulting in the creation of the document 406.

Similarly, the arrow between the documents 404 and 408 points to the document 404 to indicate that the document 404 is the parent of the document 408, and the legend “Repurpose” associated with that arrow indicates that the user's intent for making the changes was to repurpose the document 404, resulting in the creation of the document 408. The arrow between the documents 410 and 406 points to the document 406 to indicate that the document 406 is the parent of the document 410, and the legend “Revision” associated with that arrow indicates that the user's intent for making the changes was to make a revision of the document 406, resulting in the creation of the document 410. The arrow between the documents 408 and 412 points to the document 408 to indicate that the document 408 is the parent of the document 412, and the legend “Revision” associated with that arrow indicates that the user's intent for making the changes was to make a revision of the document 408, resulting in the creation of the document 412. The arrow between the documents 408 and 414 points to the document 408 to indicate that the document 408 is the parent of the document 414, and the legend “Repurpose” associated with that arrow indicates that the user's intent for making the changes was to repurpose the document 408, resulting in the creation of the document 414. The arrow between the documents 412 and 416 points to the document 412 to indicate that the document 412 is the parent of the document 416, and the legend “Revision” associated with that arrow indicates that the user's intent for making the changes was to make a revision of the document 412, resulting in the creation of the document 416. The arrow between the documents 412 and 418 points to the document 412 to indicate that the document 412 is the parent of the document 418, and the legend “Repurpose” associated with that arrow indicates that the user's intent for making the changes was to repurpose the document 412, resulting in the creation of the document 418.

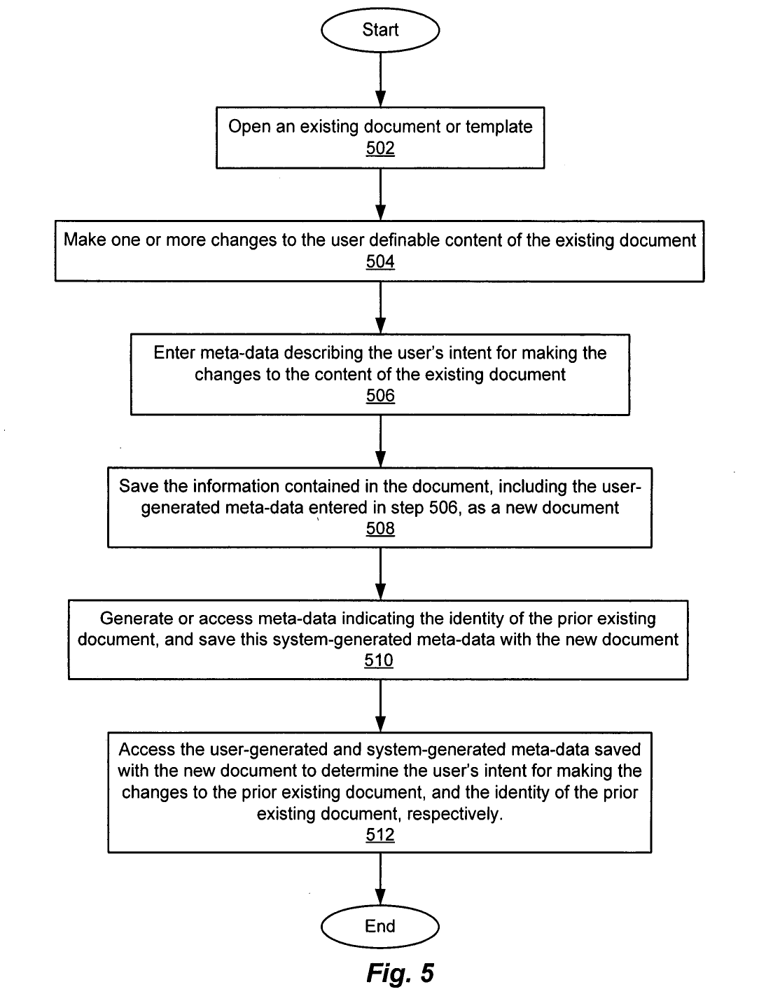

An illustrative method of operating the presently disclosed information management system for tracing the history of changes made to the content of a document by a user is described below with reference to FIG. 5. As depicted in step 502, a user opens an existing document or template using, e.g., a word processing application. Next, the user makes one or more changes to user-definable content contained in the existing document, as depicted in step 504. The user then enters meta-data describing his or her intent for making the changes to the content of the existing document, as depicted in step 506. In one embodiment, the document currently being changed by the user has a plurality of active meta-data fields embedded within the document. To enter the user-generated meta-data, the user clicks on a selected one of the active meta-data fields using a mouse, causing a pop-up display window to appear on the video display. The user then enters, using the keyboard, the meta-data describing his or her intent for making the changes to the content of the document by inputting text-based meta-data into the document via the pop-up window. For example, the user may enter the user-generated meta-data “Intent-Revision”, as depicted in FIG. 2 with reference to the meta-data 204 embedded in the document 200.

Next, as depicted in step 508, the user stores or saves the information contained in the document, including the changes made to the content and the user-generated meta-data, as a new document, which the system can store in a new file, while retaining the prior existing document (the parent document) in its original file. The system also generates (or accesses from the parent document) meta-data indicating the identity of the parent document, and stores or saves this system-generated meta-data with the new document stored in the new file, as depicted in step 510. Next, that same user or a different user opens the new file containing the newly created document, and accesses the user-generated and system-generated meta-data stored or saved in association with the new document to determine the user's intent for making the changes to the content of the parent document, and the identity of the parent document, respectively, as depicted in step 512. In one embodiment, the user may click on a selected active meta-data field within the new document to cause a pop-up display window to appear on the video display, causing representations of the information contained in the user-generated and system-generated meta-data to be displayed within the pop-up window. For example, the user-generated and system-generated meta-data included in the meta-data 204 embedded within the document 200 (see FIG. 2) may be displayed in the pop-up window.

It will be appreciated by those of ordinary skill in the art that modifications to and variations of the above-described system and method for maintaining the genealogy of documents may be made without departing from the inventive concepts disclosed herein. Accordingly, the invention should not be viewed as limited except as by the scope and spirit of the appended claims.

What is claimed is:

1. A method of managing information pertaining to the genealogy of an information storage entity, comprising the steps of:
accessing first information contained in a first information storage entity;
making at least one change to said first information;
in a first generating step, generating first meta-data associated with said at least one change;
in a first storing step, storing said first information including said at least one change in a second information storage entity; and
in a second storing step, storing said first meta-data in association with said second information storage entity.

2. The method of claim 1 wherein said first meta-data generated in said first generating step comprises meta-data describing a user's intent for making said at least one change to said first information.

3. The method of claim 2 wherein said first generating step includes selecting an indication of the user's intent from a predefined list.

4. The method of claim 2 wherein said first generating step includes determining the user's intent from a comparison of information contained in said first and second information storage entities.

5. The method of claim 1 wherein said first meta-data generated in said first generating step comprises meta-data indicating the identity of said first information storage entity containing said first information.

6. The method of claim 5 wherein said first meta-data comprises at least one of a universally unique identifier (UUID), a globally unique identifier (GUID), a checksum, a hash code, and a digital signature.

7. The method of claim 5 wherein said first generating step includes, in the event said first information contained in said first information storage entity includes an indication of the identity of said first information storage entity, accessing said indication of the identity of said first information storage entity from said first information.

8. The method of claim 1 wherein said second storing step includes storing said first meta-data in a meta-data field associated with said second information storage entity.

9. The method of claim 1 including, in a second generating step, generating second meta-data indicating the identity of said second information storage entity, and, in a third storing step, storing said second meta-data in association with said second information storage entity.

10. The method of claim 1 wherein said first and second information storage entities comprise one of respective first and second documents and respective first and second templates.

11. The method of claim 10 wherein said first and second information storage entities comprise respective first and second documents, and wherein each of said first and second documents has a format based on the extended markup language (XML).

12. The method of claim 10 wherein said first and second information storage entities comprise respective first and second documents, and wherein information and meta-data contained in said first and second documents conform to the XML data model for engineering (XDME).

13. The method of claim 10 including, in a third storing step, storing said one of said respective first and second documents and said respective first and second templates in a storage medium.

14. The method of claim 13 wherein said third storing step includes retaining each of said one of said respective first and second documents and said respective first and second templates in a separate file.

15. The method of claim 10 wherein said respective documents comprise one of respective worksheets, respective spreadsheets, respective tables, respective data files, respective media files, and respective program files.

16. The method of claim 10 wherein said first and second information storage entities comprise respective first and second documents, wherein said first meta-data generated in said first generating step comprises meta-data describing a user's intent for making said at least one change to said first information, and wherein said user's intent comprises one of creating a revision of said first document, repurposing said first document, and making a meta-data change.

17. The method of claim 1 including, in a second generating step, generating a representation of a tree conceptually illustrating a genealogy of said second information storage entity.

18. The method of claim 17 including selecting one of said first information storage entity and said second information storage entity to correspond to the root of said tree.

19. The method of claim 1 wherein said first information storage entity comprises a document, wherein said first information comprises content contained in said document, and wherein said first meta-data describes a user's intent for making at least one change to said content.

20. The method of claim 1 wherein said first information storage entity comprises a document, wherein said first information comprises a portion of content contained in said document, and wherein said first meta-data describes a user's intent for making at least one change to said portion of content.

21. A system for managing information pertaining to the genealogy of an information storage entity, comprising:
at least one computer including at least one processor and at least one memory; and
wherein said at least one computer is operative to execute at least one user application program out of said at least one memory:
to access first information contained in a first information storage entity;
to make at least one change to said first information;
to generate first meta-data associated with said at least one change;
to store said first information including said at least one change in a second information storage entity; and
to store said first meta-data in association with said second information storage entity.

22. The system of claim 21 wherein said first meta-data comprises meta-data describing a user's intent for making said at least one change to said first information.

23. The system of claim 21 wherein said first meta-data comprises meta-data indicating the identity of said first information storage entity containing said first information.

24. The system of claim 21 wherein said at least one computer includes local information storage media, and wherein said first and second information storage entities are contained in said local information storage media.

25. The system of claim 21 including at least one computer network, wherein said at least one computer comprises a plurality of computers, and wherein each of said plurality of computers is communicably coupled to said network.

26. The system of claim 21 wherein said first and second information storage entities comprise respective first and second documents.

27. The system of claim 26 wherein each of said first and second documents has a format based on the extended markup language (XML).

28. The system of claim 26 wherein information and meta-data contained in each of said first and second documents conform to the XML data model for engineering (XDME).

29. The system of claim 26 wherein said first and second documents comprise one of respective worksheets, respective spreadsheets, respective tables, respective data files, respective media files, and respective program files.

30. The system of claim 21 wherein said at least one computer includes at least one display, and wherein said at least one computer is operative to execute said at least one user application program out of said at least one memory to generate at least one representation of at least one tree, and to display said at least one representation of said at least one tree on said at least one display, said at least one tree conceptually illustrating a genealogy of said second information storage entity.
